(19) United States
(12) Patent Application Publication
(10) Pub. No.: US 2005/0239504 A1
(43) Pub. Date: Oct. 27, 2005

(54) SIM-based automatic feature activation for mobile phones

(75) Inventors: Atsushi Ishii, Vancouver, WA (US); Narasimhan Parthasarathy, Vancouver, WA (US)

Correspondence Address: ROBERT D. VARITZ, 4915 S.E. 33RD PLACE, PORTLAND, OR, 97202, US

(73) Assignee: Sharp Laboratories of America, Inc.

(21) Appl. No.: 10/830,755

(22) Filed: Apr. 23, 2004

(51) Int. Cl. H04M 1/00

(52) U.S. Cl. 455/558; 455/550.1

(57) ABSTRACT

A method of feature activation in a SIM-equipped mobile phone associated with a communications network and a server includes storing a subscriber profile in a database of the server, wherein the subscriber profile contains a list of activated features and a list of deactivated features associated with the subscriber; and transmitting the subscriber profile to the SIM-equipped mobile phone upon request by the SIM-equipped mobile phone.

### FIELD OF THE INVENTION

This invention relates to mobile phones, and specifically to activation of client subscription information in plural mobile handsets.

### BACKGROUND OF THE INVENTION

Currently, some of the features supported in mobile phones must be activated after purchasing the phone and before a client can use the full capabilities of the phone. Such features include, e.g., activation of a web browser, and activation of a client for a Multimedia Messaging Service (MMS). To activate such features, a new phone owner may need to call a service center associated with the service provider to obtain a special key sequence, which allows the subscriber to activate the special features using the keypad of the phone. Alternatively, the service center may send a specially encoded message to the mobile phone which initiates automatic activation of the special features.

Activation of a special feature causes a program embedded in the mobile phone to become active and available to the subscriber. This is accomplished in any of several ways. In some cases, a “flag” is set in the phone's memory. In other cases a lock code for the feature is unlocked.

Each subscriber to a cellular phone network, such as GSM, has a Subscriber Identity Module (SIM), which is a detachable memory card containing International Mobile Subscriber Identity (IMSI), a unique identification number for each SIM which identifies a subscriber. A SIM may be swapped between mobile phones.

The portability of subscription by a SIM, however, may cause inconvenience for the subscriber. For instance, if a subscriber removes the subscriber's SIM from a first mobile phone (Phone 1) and inserts the SIM into a second mobile phone (Phone 2), the features activated in Phone 1 are not be available to the subscriber in Phone 2. To use the same features on Phone 2, the subscriber must repeat the activation procedure as done for Phone 1. The features activated in Phone 1, however, remain active even if another subscriber inserts the subscriber's own SIM into Phone 1. This makes it difficult for cellular carriers to manage the profile, i.e., a list of activated features, for each subscriber.

U.S. Pat. No. 6,014,561 B1, for Method and apparatus for over the air activation of a multiple mode/band radio telephone handset, to Molne, granted Jan. 11, 2000, describes a method including generating a message containing instructions and predetermined activation information for a first mode/band of operation and a second mode/band of operation; sending the message over the air from a communications network to the handset to activate the handset for operation in the first mode/band of operation and the second mode/band of operation; and storing the activation information in at least one selected memory area.

U.S. Pat. No. 6,301,484 B1, for Method and apparatus for remote activation of wireless device features using short message services (SMS), to Rogers et al, granted Oct. 9, 2001, describes control of the phone features using SMS messages, wherein a feature control message is an SMS message designated as feature control message, beginning with a start of message delimiter. A start of message delimiter is defined as a set of characters that normally do not begin a message and that normally do not occur in succession. Once the phone has determined that a start of message delimiter has been received, the phone enters an SMS feature control routine. Successive predetermined data fields within the SMS message are parsed to provide the specific feature control information.

U.S. Pat. No. 6,591,098 B1, for System and method for using a temporary electronic serial number for over-the-air activation of a mobile device, to Shieh et al., granted Jul. 8, 2003, describes enablement of an ANSI-136/41 or PCS wireless network to recognize a SIM-based mobile device during the registration process so that the correct OAA procedures can be invoked for the mobile device.

U.S. Patent Publication No. 2003/0153302, for System for the centralized storage of wireless customer information, of Lewis et al., published Aug. 14, 2003, describes a data storage device which includes a subscriber profile portion for storing personal information about a subscriber. The subscriber profile portion includes a subscriber identification portion for storing an identification string. The subscriber profile portion is associated with an account type portion for storing account information, a portal portion for storing portal information, and an account status portion for storing account status information. The data storage device further includes a subscription portion for storing subscription information. The subscription portion is associated with a device portion for storing device information, a services portion for storing services information, and a mobile subscription portion for storing mobile subscription information.

U.S. Patent Publication No. U.S. 2003/0211861, for Method, apparatus and article to remotely associate wireless communications devices with subscriber identities and/or proxy wireless communications devices, to Castrogiovanni, et al., published Nov. 13, 2003; U.S. Patent Publication No. U.S. 2003/0212616, for Method, apparatus and article to remotely associate wireless communications devices with subscriber identities and/or proxy wireless communications devices, to Castrogiovanni et al, published Nov. 13, 2003; and U.S. Patent Publication No. U.S. 2003/0220101, for Method, apparatus and article to remotely associate wireless communications devices with subscriber identities and/or proxy wireless communications devices, to Castrogiovanni et al, published Nov. 27, 2003, describe remote testing of a device which may be limited by the subscriber identification information and/or subscriber configuration information stored in the wireless communications devices at the remote test platforms. Updating this information typically requires a visit by a technician. The requirement that a SIM be physically received in a SIM slot of a wireless communications device also requires the ownership of more SIMs than would be typically be desired during actual testing.

U.S. Patent Publication No. 2003/0224823, for Method and apparatus for facilitating over-the-air activation of pre-programmed memory devices, to Hurst, et al, published Dec. 4, 2003, describes a method for allowing access to secure content via a mobile terminal. The method includes providing a removable memory device for coupling to the mobile terminal, where the removable memory device is pre-programmed with secure content and a secure rights database of rights files. The method further includes conducting over-the-air (OTA) activation of the secure content stored on the removable memory device in response to an attempt to access the secure content. Access to the secure content is enabled as dictated by corresponding rights file when the OTA activation has successfully completed.

WO 97/22210, for Call setup gateway for telecommunications system, of Low et al, published Jun. 19, 1997, describes a third-party call setup gateway provided for establishing bearer channels through a switched telecommunications system by controlling an associated switch. An interface to a computer network is provided for access by users of the telecommunications system. A user locates a potential callee's phone number, e.g., from the callee's web site, and transmits the user's number and callee's number to the gateway, which commands the switch to establish a call between the user and the callee.

GB2382440, for Secure activation, of Sprenger, published May 28, 2003, describes activation of a communication device by transmitting the devices identification to a network, and transmitting activation codes to the device.

### SUMMARY OF THE INVENTION

A method of feature activation in a SIM-equipped mobile phone associated with a communications network and a server includes storing a subscriber profile in a database of the server, wherein the subscriber profile contains a list of activated features and a list of deactivated features associated with the subscriber; and transmitting the subscriber profile to the SIM-equipped mobile phone upon request by the SIM-equipped mobile phone.

It is an object of the invention to provide for activation of mobile phone features in a SIM-equipped mobile phone.

Another object of the invention is to provide for portability of SIMs between mobile phones along with portability and automatic activation of mobile phone features specific to the subscriber's profile.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a schematic representation of the invention.

FIG. 2 is a block diagram of the method of the invention.

### DETAILED DESCRIPTION OF THE PREFERRED EMBODIMENTS

The present invention provides a method to bind a feature embedded in mobile phones to subscriber's identity module (SIM), so that such a feature may be properly activated or deactivated when the SIM is ported to a different mobile phone. The invention provides for storage of a subscriber/user profile to be stored in a database of a centralized server. When requested by a mobile phone, the server transmits the requisite profile to the mobile phone containing the subscriber's SIM, a subscriber-specific SIM, which profile contains a list of features that may be activated, and another list of feature that must be deactivated. The method of the invention provides that activated features are available to the subscriber even if the subscriber's SIM is ported to another phone. Likewise, such features are disabled for other users using the subscriber's original phone. The method of the invention provides a means to dynamically activate/deactivate features based on the capabilities of the network.

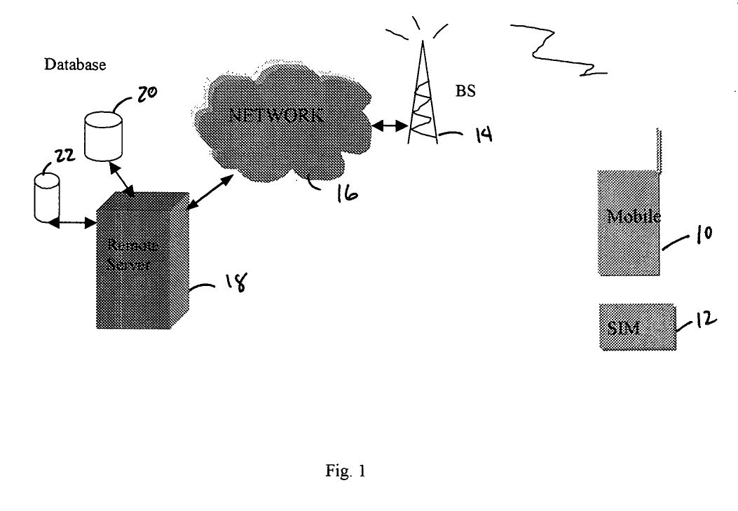

Referring now to FIG. 1, the method of the invention assumes that a mobile phone 10 is pre-programmed with a set of features, some of which are contained in SIM 12. Phone 10 is in contact with a base station 14, which is connected to a network 16, using a remote server 18, and plural databases 20, 22. Each feature is a program (application) embedded in the memory of the mobile phone. Some of those features may be always available to any subscriber, regardless of what SIM is installed in the phone, whereas others may be disabled by default and need to be activated by the subscriber. There are several ways to prevent subscribers from accessing disabled features. For example, the menu item for such a disabled feature can be grayed out in, or can be completely removed from in the human machine interface.

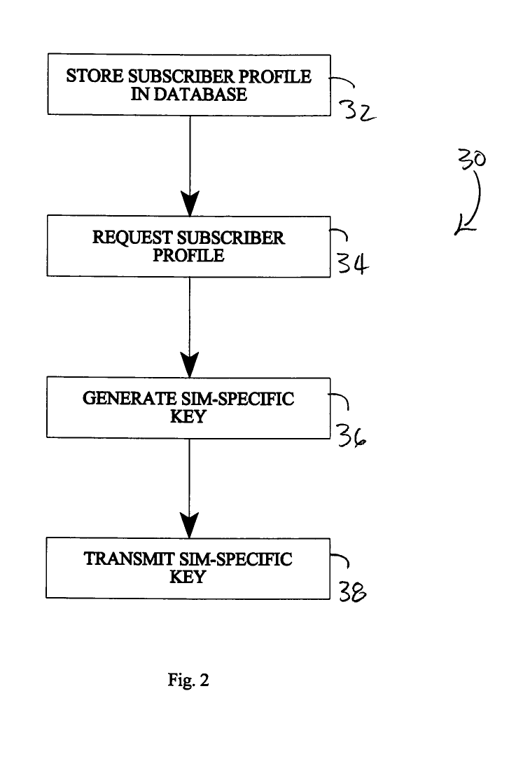

The method of the invention, depicted generally at 30 in FIG. 2, includes several ways to activate disabled features. A subscriber's profile is stored, 32, in database 20, 22. The subscriber may enter a special key code, using the keypad of the mobile phone. Alternatively, cellular network 16 can send a specially encoded message to the mobile phone. The latter method is more desirable because of reliability and convenience. Either way, mobile phone 10 requests, 34, the subscriber profile.

In the first embodiment of the method of the invention, when a new or changed SIM is detected by the mobile phone, the mobile phone formulates a message, i.e., a request, which includes relevant information, such as its handset type and the IMSI of the SIM. This information is packaged and sent to network 16 to remote server 18, e.g., a short message service (SMS) message to a predefined address. The information received by remote server 18 is processed against existing databases 20, 22, e.g., subscriber database, handset database, etc., to generate a “key,” 36. To generate the key, the databases contains a set of activated features and disabled features for each subscriber identified by an IMSI. Remote server 18 then packages the key and sends it, 38, over network 16 to mobile phone 10. The “key” may be secured using various encryption mechanisms. Mobile phone 10 parses the “key” and activates and/or deactivates the features described by the parsed contents. Such an action may lead to silent enabling/disabling of features in the human machine interface.

If a first subscriber moves his/her SIM from one mobile phone to another, both equipped with the method of the present invention, the remote server instructs the second mobile phone to activate the same set of features previously activated on the first mobile phone. Later, if a second subscriber inserts his/her SIM into the first mobile phone, the remote server configures the first mobile phone with a different set of features based on the second subscriber's profile.

The remote server may examine the handset type reported by mobile phones. The handset database contains a list of embedded features for each handset type. In the above scenario, if the second mobile phone does not support all the features that the first subscriber has activated, the remote server may compose a “key” with a subset of the activated features. Likewise, if a mobile phone receives a key indicating unsupported features, it ignores such features and optionally provides a negative feedback to the remote server.

When a SIM for which certain features were activated is replaced by another SIM, the mobile phone disables the features activated by the first SIM until the server grants activation with the second SIM.

The method of the invention provides for use of a “specially marked” SIM in another embodiment of the method of the invention. A “specially marked” SIM is a SIM which is programmed to contain data which flags the SIM as a subscriber for special features. The mobile phone sends a message to the remote server every time such a SIM is plugged in. On the other hand, it does not need to send a message to the remote server if a detected SIM is not “specially marked”. In doing so, it is possible to avoid unnecessary traffic.

Alternatively, the detection of a SIM may not trigger the process for activation of a feature. This assumes that features that need activation are disabled in the human machine interface by some mechanism, e.g., grayed out. When the subscriber tries to use the feature then a request for activation is processed as described above.

In another embodiment of the invention, the mobile phone formulates a message, as described in the first embodiment, and sends the message to a remote server whenever moving from one location area to another. A processing similar to the one described in the first embodiment is used to activate/deactivate features. A benefit of this embodiment is that network-dependant features, which may or may not be supported in the new location area, may be managed.

Thus, a SIM-based automatic feature activation for mobile phones has been disclosed. It will be appreciated that further variations and modifications thereof may be made within the scope of the invention as defined in the appended claims.

1. A method of feature activation in a SIM-equipped mobile phone associated with a communications network and a server, comprising:
storing a subscriber profile in a database of the server, wherein the subscriber profile contains a list of activated features and a list of deactivated features associated with the subscriber; and
transmitting the subscriber profile to the SIM-equipped mobile phone upon request by the SIM-equipped mobile phone.

2. The method of claim 1 wherein said transmitting occurs when a subscriber transfers a subscriber-specific SIM to a SIM-equipped mobile phone.

3. The method of claim 2 wherein a request is a SMS sent through the communications network to the server and wherein the subscriber profile is retrieved from the database.

4. The method of claim 3 wherein the subscriber profile is sent to the SIM-equipped mobile phone as an encrypted key.

5. The method of claim 1 which includes providing a specially marked SIM, wherein only a specially marked SIM causes the SIM-equipped mobile phone the generate a request.

6. A method of feature activation in a SIM-equipped mobile phone associated with a communications network and a server, comprising:
storing a subscriber profile in a database of the server, wherein the subscriber profile contains a list of activated features and a list of deactivated features associated with the subscriber; and
transmitting the subscriber profile to the SIM-equipped mobile phone upon request by the SIM-equipped mobile phone when a subscriber transfers a subscriber-specific SIM to a SIM-equipped mobile phone.

7. The method of claim 6 wherein a request is a SMS sent through the communications network to the server and wherein the subscriber profile is retrieved from the database.

8. The method of claim 7 wherein the subscriber profile is sent to the SIM-equipped mobile phone as an encrypted key.

9. The method of claim 6 which includes providing a specially marked SIM, wherein only a specially marked SIM causes the SIM-equipped mobile phone the generate a request.

10. A method of feature activation in a SIM-equipped mobile phone associated with a communications network and a server, comprising:
storing a subscriber profile in a database of the server, wherein the subscriber profile contains a list of activated features and a list of deactivated features associated with the subscriber; and
transmitting the subscriber profile to the SIM-equipped mobile phone upon request by the SIM-equipped mobile phone, wherein a request is a SMS sent through the communications network to the server and wherein the subscriber profile is retrieved from the database.

11. The method of claim 10 wherein said transmitting occurs when a subscriber transfers a subscriber-specific SIM to a SIM-equipped mobile phone.

12. The method of claim 11 wherein the subscriber profile is sent to the SIM-equipped mobile phone as an encrypted key.

13. The method of claim 10 which includes providing a specially marked SIM, wherein only a specially marked SIM causes the SIM-equipped mobile phone the generate a request.
